(19) United States
(12) Patent Application Publication
(10) Pub. No.: US 2010/0039425 A1
(43) Pub. Date: Feb. 18, 2010

(54) COLOR SEQUENTIAL LIQUID CRYSTAL DISPLAY AND PIXEL CIRCUIT THEREOF

(75) Inventors: Chung-Chun Chen, Kaohsiung City (TW); Chun-Huai Li, Hsinchu County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: AU OPTRONICS CORPORATION, Hsinchu (TW)

(21) Appl. No.: 12/336,540

(22) Filed: Dec. 17, 2008

(30) Foreign Application Priority Data
Aug. 18, 2008 (TW) 97131426

(51) Int. Cl. G09G 5/00; G09G 3/36

(52) U.S. Cl. 345/214; 345/88

(57) ABSTRACT

A color sequential liquid crystal display and a pixel circuit thereof are provided. The pixel circuit includes a first and a second sampling switches, a first and a second voltage registers, a first and a second output switches, a liquid crystal (LC) capacitor, and a reset switch. The first voltage register is coupled to the first sampling and the first output switches to register a first sampling voltage during a first sub-frame, and output the first sampling voltage to the LC capacitor during a second sub-frame. The second voltage register is coupled to the second sampling and the second output switches to register a second sampling voltage during the second sub-frame, and output the second sampling voltage to the LC capacitor during the first sub-frame. The reset switch is coupled to the LC capacitor to transmit a reset voltage to the LC capacitor between the first and second sub-frame periods.

### CROSS-REFERENCE TO RELATED APPLICATION

This application claims the priority benefit of Taiwan application serial no. 97131426, filed on Aug. 18, 2008. The entirety of the above-mentioned patent application is hereby incorporated by reference herein and made a part of this specification.

### BACKGROUND OF THE INVENTION

1. Field of the Invention

The present invention relates to a flat panel display technology and particularly to a color sequential liquid crystal display and a pixel circuit thereof.

2. Description of Related Art

As technologies in optoelectronics and semiconductors advance, flat panel displays also flourish accordingly. Among various flat panel displays, the liquid crystal display (LCD) has become the mainstream in the market because of its superior characteristics, such as high space utilization, low power consumption, no radiation and low electromagnetic disturbance. Generally, the conventional LCD panel displays the colors and luminance an image data wishes to present by intermixing sub-pixels of the three primary colors (i.e., red sub-pixels, green sub-pixels, and blue sub-pixels) along the space axis.

Accordingly, color filters of the three colors—red, green and blue—have to be disposed above each of the pixels in the conventional LCD panel, and a white backlight source is also employed to achieve the display method of intermixing the three primary colors through the color filters in each pixel. However, since a sub-pixel of each color can only let through the light energy of the color, the colored light can only penetrate through one-third of the space. Moreover, since the color filters absorb light energies, the efficiency of light energy utilization would decline. To overcome the drawback in the display method of intermixing the three primary colors, the color sequential method becomes a display method capable of reducing consumption of light energy.

The color sequential method changes the way the color filters are originally intermixed on the space axis, i.e., intermixing red, green and blue sub-pixels on the space axis within an area smaller than the view angle of human eyes, into the way that intermixing the colors through the backlight source of the light-emitting diode (LED) on the time axis, i.e., rapidly switching among red, green and blue images on the time axis to generate the effect of intermixing colors within the time frame permitted by visual persistence of human eyes. FIG. 1 is an operational timing sequence diagram of a conventional color sequential LCD. Referring to FIG. 1, each sub-frame is about one-third of the time of the conventional frame (about 5.56 ms, 180 Hz). Each sub-frame includes an addressing time, an LC response time and an illumination time. The three periods of time would proceed sequentially in a sub-frame to display a corresponding sub-frame (i.e., a red, green or blue sub-frame).

Taking red sub-frame periods for example, first red data signals are written into each of the pixels in the LCD. Thereafter, after liquid crystal atoms of each pixel respond for a period, an LED backlight module is turned on to provide a red backlight source. Thus, a red sub-frame would display. After red sub-frame periods finish displaying, green sub-frame periods and blue sub-frame periods would continue displaying to rapidly switch among red, green and blue images on the time axis to generate the effect of intermixing of the colors.

However, since the color sequential method adapted to write data is a row-by-row response method, in which red data signals must be inputted row by row until the entire frame is written with the data and then the red backlight source is turned on for displaying. Consequently, the LC response tends to become uneven. In addition, the color sequential method must be operated more rapidly than the conventional space color-intermixing LCD is operated. Generally, the color sequential method must be operated at a speed more than 180 Hz to achieve a satisfactory display quality.

Accordingly, if the color sequential method is operated too slowly, color breakup will be occurred. Considering the required high operation speed as aforementioned along with the limitation that each sub-frame needs to spare an independent addressing time, the LC response time and the illumination time would therefore be significantly reduced.

### SUMMARY OF THE INVENTION

The present invention provides a color sequential liquid crystal display (LCD) and a pixel circuit thereof. According to the present invention, a first voltage register and a second voltage register synchronously and alternately perform operations of outputting data signals and reading data signals so that the data signals of sub-frame periods are written and displayed simultaneously. As a result, the illumination time of each color in the color sequential LCD is increased.

The present invention provides a pixel circuit of a color sequential LCD. The pixel circuit includes a first and a second sampling switches, a first voltage register, a second voltage register, a first and a second output switches, a liquid crystal capacitor, and a reset switch. The first and the second sampling switches transmit a first and a second sampling voltages during a first and a second sub-frame periods, respectively. The first voltage register is coupled to the first sampling switch for registering the first sampling voltage during the first sub-frame period and transmitting the first sampling voltage during the second sub-frame period. The second voltage register is coupled to the second sampling switch for registering the second sampling voltage during the second sub-frame period and transmitting the second sampling voltage during the first sub-frame period. The first and the second output switches are coupled to the first and the second voltage registers respectively for transmitting the first and the second sampling voltages during the second and the first sub-frame periods. The liquid crystal capacitor is coupled to the first output switch, the second output switch and a common voltage for receiving the second and the first sampling voltages during the first and the second sub-frame periods, respectively. The reset switch is coupled to the liquid crystal capacitor for transmitting a reset voltage to reset the liquid crystal capacitor before the first and the second output switches transmit the first and the second sampling voltages during the second and the first sub-frame periods respectively.

The present invention further provides a color sequential LCD including an LCD panel which at least includes a pixel circuit. The pixel circuit includes a first and a second sampling switches, a first voltage register, a second voltage register, a first and a second output switches, a liquid crystal capacitor, and a reset switch. The first and the second sampling switches transmit a first and a second sampling voltages during a first and a second sub-frame periods, respectively. The first voltage register is coupled to the first sampling switch to register the first sampling voltage during the first sub-frame period and outputting the first sampling voltage during the second sub-frame period. The second voltage register is coupled to the second sampling switch for registering the second sampling voltage during the second sub-frame period and outputting the second sampling voltage during the first sub-frame period. The first and the second output switches are coupled to the first and the second voltage registers respectively to transmit the first and the second sampling voltages during the second and the first sub-frame periods. The liquid crystal capacitor is coupled to the first output switch, the second output switch and a common voltage to receive the second and the first sampling voltages during the first and the second sub-frame periods, respectively. The reset switch is coupled to the liquid crystal capacitor to transmit a reset voltage to reset the liquid crystal capacitor before the first and the second output switches transmit the first and the second sampling voltages during the second and the first sub-frame periods respectively.

According to the pixel circuit of the color sequential LCD in an embodiment of the present invention, the first and the second voltage registers are capacitive voltage registers. According to the pixel circuit of the color sequential LCD in an embodiment of the present invention, each of the first and the second voltage registers is constituted by at least one capacitor.

According to the pixel circuit of the color sequential LCD in an embodiment of the present invention, each of the first and the second voltage registers is constituted by at least one capacitor and one analog buffer.

According to the pixel circuit of the color sequential LCD in an embodiment of the present invention, the second voltage register and the liquid crystal capacitor perform a charge sharing process during the first sub-frame period to determine a gray scale of the pixel circuit.

According to the pixel circuit of the color sequential LCD in an embodiment of the present invention, the first voltage register and the liquid crystal capacitor perform a charge sharing process during the second sub-frame period to determine a gray scale of the pixel circuit.

According to the color sequential LCD in an embodiment of the present invention, the LCD panel at least includes a first and a second scan lines and data lines. The first and the second scan lines are coupled to the first and the second sampling switches respectively for transmitting a first and a second scan signals during the first and the second sub-frame periods to enable the first and the second sampling switches respectively. The data line is coupled to the first and the second sampling switches for transmitting the first and the second sampling voltages during the first and the second sub-frame periods respectively.

According to an embodiment of the present invention, the color sequential LCD further includes a timing controller, a gate driver and a source driver. The gate driver is coupled to and controlled by the timing controller to generate the first and the second scan signals to the first and the second scan lines during the first and the second sub-frame periods respectively. The source driver is coupled to and controlled by the timing controller to generate the first and the second sampling voltages to the data lines during the first and the second sub-frame periods respectively.

According to an embodiment of the present invention, the color sequential LCD further includes a light-emitting diode (LED) backlight module for providing a surface light source required by the LCD panel.

According to an embodiment of the present invention, the color sequential LCD further includes a control unit coupled to the first output switch, the second output switch and the reset switch. The control unit provides a first control signal to enable the reset switch before the first and the second output switches transmit the first and the second sampling voltages during the second and the first sub-frame periods respectively.

According to an embodiment of the present invention, the color sequential LCD further includes a reset voltage generator coupled to the reset switch. The reset voltage generator provides the reset voltage to the reset switch before the first and the second output switches transmit the first and the second sampling voltages during the second and the first sub-frame periods respectively.

According to an embodiment of the present invention, the control unit of the color sequential LCD further provides a third and a second control signals respectively to enable the first and the second output switches after resetting the liquid crystal capacitor during the first and the second sub-frame periods.

According to an embodiment of the present invention, the first and the second voltage registers of the color sequential LCD are capacitive voltage registers. According to another embodiment, each of the first and the second voltage registers is constituted by at least one capacitor. According to yet another embodiment, each of the first and the second voltage registers is constituted by at least one capacitor and one analog buffer.

According to an embodiment of the present invention, the second voltage register and the liquid crystal capacitor perform a charge sharing process during the first sub-frame period to determine a gray scale of the pixel circuit of the color sequential LCD.

According to an embodiment of the present invention, the first voltage register and the liquid crystal capacitor perform a charge sharing process during the second sub-frame period to determine a gray scale of the pixel circuit of the color sequential LCD.

In the present invention, the pixel circuit employs a structure having two voltage registers including the first voltage register and the second voltage register. When one of the voltage registers is reading data, the other voltage register is simultaneously displaying previously stored data signals on pixels to write data signals in the sub-frame and illuminate a signal-color light source so as to increase operation efficiency of the pixel circuit and prolong the illumination time of the pixels.

In order to make the aforementioned and other objects, features and advantages of the present invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is an operational timing sequence diagram of a conventional color sequential LCD.

FIG. 2 is a system block diagram of a color sequential LCD according to an embodiment of the present invention.

FIG. 3 shows a circuit diagram of a portion (2×2) of the pixel circuit in the LCD panel of FIG. 2.

FIGS. 4A and 4B are schematic views of respective implementation modes of voltage registers according to an embodiment of the present invention.

FIGS. 5A, 5B and 5C are schematic views showing a charge sharing process in a pixel circuit according to an embodiment of the present invention.

FIG. 6 is an operational timing sequence diagram of a color sequential LCD according to an embodiment of the present invention.

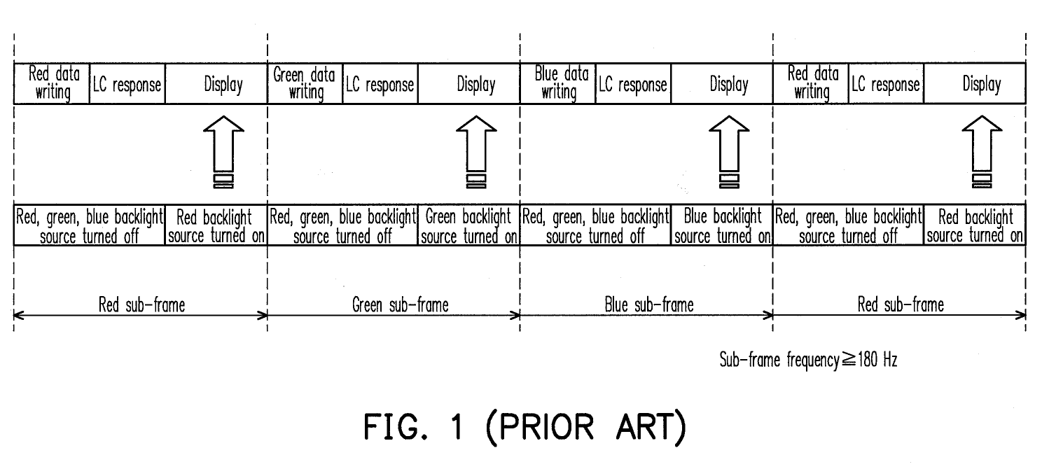

### DESCRIPTION OF EMBODIMENTS

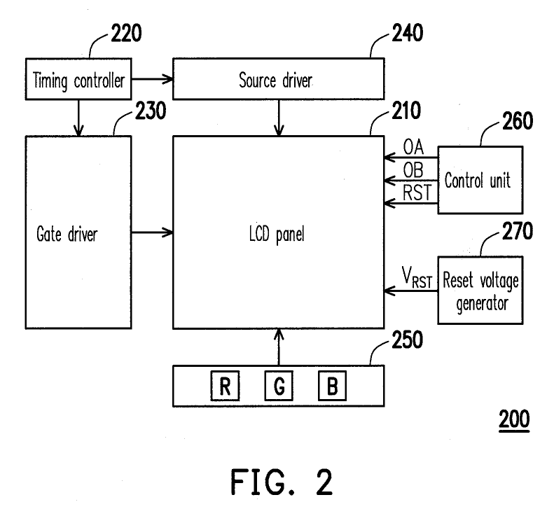

FIG. 2 is a system block diagram of a color sequential LCD 200 according to an embodiment of the present invention. Referring to FIG. 2, the color sequential LCD 200 includes an LCD panel 210, a timing controller 220, a gate driver 230, a source driver 240, a light-emitting diode (LED) backlight module 250, a control unit 260 and a reset voltage generator 270. The timing controller 220 is coupled to the gate driver 230 and the source driver 240 and provides a control signal to the gate driver 230 and the source driver 240. The gate driver 230 is coupled to the LCD panel 210 to sequentially provide scan signals to the LCD panel 210. The gate driver 240 is coupled to the LCD panel 210 to provide data signals to the LCD panel 210.

The LED backlight module 250 is disposed under the LCD panel 210 (or alternatively disposed at a side of light guide, not shown) to provide a red, a green and a blue single-color light sources respectively to the LCD panel 210 to achieve the color sequential display effect when the LCD panel 210 is displaying a red, a green and a blue sub-frames. The control unit 260 is coupled to the LCD panel 210 to provide a first control signal RST, a second control signal OB and a third control signal OA to the LCD panel 210. The reset voltage generator 270 is coupled to the LCD panel 210 to provide a reset voltage V_{RST} to the LCD panel 210.

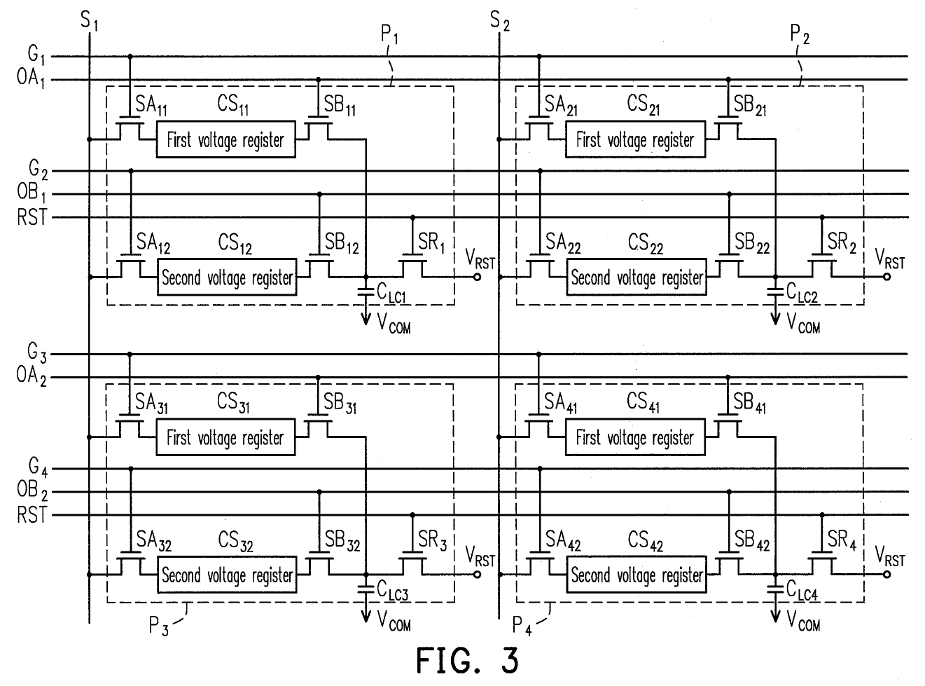

FIG. 3 shows a circuit diagram of a portion (2×2) of pixel circuits P₁-P₄ in the LCD panel 210. Referring to both FIGS. 2 and 3, the LCD panel 210 includes liquid crystal capacitors C_{LC1}-C_{LC4}, first sampling switches SA₁₁, SA₂₁, SA₃₁ and SA₄₁, second sampling switches SA₁₂, SA₂₂, SA₃₂ and SA₄₂, first output switches SB₁₁, SB₂₁, SB₃₁ and SB₄₁, second output switches SB₁₂, SB₂₂, SB₃₂ and SB₄₂, reset switches SR₁-SR₄, scan lines G₁-G₄, first voltage registers CS₁₁, CS₂₁, CS₃₁, and CS₄₁, second voltage registers CS₁₂, CS₂₂, CS₃₂ and CS₄₂, and data lines S₁ and S₂.

The scan lines G₁-G₄ sequentially transmit the scan signals outputted by the gate driver 230. The data lines S₁ and S₂ transmit the data signals outputted by the source driver 240 to provide to the pixel circuits P₁-P₄ correspondingly. The first control signal RST, second control signals OB₁ and OB₂, and third control signals OA₁ and OA₂ are outputted by the control unit 260 to control operations of the reset switches SR₁-SR₄, the second output switches SB₁₂, SB₂₂, SB₃₂ and SB₄₂, and the first output switches SB₁₁, SB₂₁, SB₃₁ and SB₄₁ in each of the pixel circuits P₁-P₄ respectively.

The reset voltage V_{RST} is outputted from the reset voltage generator 270 to reset the liquid crystal capacitors C_{LC1}, C_{LC2}, C_{LC3} and C_{LC4} in each of the pixel circuits P₁-P₄. The circuit structure and operation principle of the pixel circuit P₁ are described below followed by a description of the overall operation of the pixel circuits P₁-P₄.

The pixel circuit P₁ includes the liquid crystal capacitor C_{LC1}, the first sampling switch SA₁₁, the second sampling switch SA₁₂, the first output switch SB₁₁, the second output switch SB₁₂, the reset switch SR₁, the first voltage register CS₁₁ and the second voltage register CS₁₂. The first and the second voltage registers CS₁₁ and CS₁₂ are coupled to the first and the second sampling switches SA₁₁ and SA₁₂ respectively to store a first and a second sampling voltages. When the first sampling switch SA₁₁ is turned on, the second sampling switch SA₁₂ is turned off. The data line S₁ provides corresponding data signals to the first voltage register CS₁₁, and the data signals stored in the first voltage register CS₁₁ are the first sampling voltage.

Similarly, when the second sampling switch SA₁₂ is turned on, the first sampling switch SA₁₁ is turned off. The data line S₁ provides corresponding data signals to the second voltage register CS₁₂, and the data signals stored in the second voltage register CS₁₂ are the second sampling voltage. The first and the second output switches SB₁₁ and SB₁₂ are coupled to the first and the second voltage registers CS₁₁ and CS₁₂ respectively to write the first or the second sampling voltage to the liquid crystal capacitor C_{LC1} from the first and the second voltage registers CS₁₁ and CS₁₂. The liquid crystal capacitor C_{LC1} is coupled to the first and the second output switches to receive the first or the second sampling voltage. The reset switch SR₁ is coupled to the liquid crystal capacitor C_{LC1} to transmit the reset voltage V_{RST} to the liquid crystal capacitor C_{LC1} so as to reset the liquid crystal capacitor C_{LC1}.

The operation principle of the pixel circuit P₁ in FIG. 3 is described in the following. First, during a first sub-frame period of an N^{th} frame of the pixel circuit P₁ (such as a red sub-frame), the liquid crystal capacitor C_{LC1} is reset in preparation for receiving data signals desired to be displayed. At the moment, the first and the second output switches SB₁₁ and SB₁₂ are both turned off, and the reset switch SR₁ is turned on so that the liquid crystal capacitor C_{LC1} charges or discharges to the reset voltage V_{RST}. After the liquid crystal capacitor C_{LC1} finishes charging or discharging, the reset switch SR₁ is then turned off again. After the liquid crystal capacitor C_{LC1} finishes resetting, the first sampling switch SA₁₁ is turned on for the first voltage register CS₁₁ to store the first sampling voltage. At the same time when the first sampling switch SA₁₁ is turned on, the second output switch SB₁₂ is also turned on to transmit the second sampling voltage stored in the second voltage register CS₁₂ in the last sub-frame (i.e., a blue sub-frame of an (N−1)^{th} frame of the pixel circuit P₁) to the liquid crystal capacitor C_{LC1}.

Shortly afterwards, when the pixel circuit P₁ enters a second sub-frame (such as a green sub-frame of the N^{th} frame of the pixel circuit P₁), the liquid crystal capacitor C_{LC1} is reset again. The first and the second output switches SB₁₁ and SB₁₂ are both turned off, and the reset switch SR₁ is turned on so that the liquid crystal capacitor C_{LC1} charges or discharges to the reset voltage V_{RST}. After the liquid crystal capacitor C_{LC1} finishes charging or discharging, the reset switch SR₁ is then turned off again. Next, the second sampling switch SA₁₂ is turned on for the second voltage register CS₁₂ to store the second sampling voltage. At the same time when the second sampling switch SA₁₂ is turned on, the first output switch SB₁₁ is also turned on to transmit the first sampling voltage stored in the first voltage register CS₁₁ in the last sub-frame (i.e., a red sub-frame of the N^{th} frame of the pixel circuit P₁) to the liquid crystal capacitor C_{LC1}.

Pursuant to the said operation principle of the pixel circuit P₁, the first and the second voltage registers CS₁₁ and CS₁₂ repeatedly, alternately and synchronously store the first or the second sampling voltage and output the first or the second sampling voltage to the liquid crystal capacitor C_{LC1}. Therefore, it is conceivable that the pixel circuit P₁ employs an analog sample and hold circuit structure.

More specifically, the first voltage register CS₁₁ repeatedly reads and outputs the first sampling voltage, and the second voltage register CS₁₂ repeatedly reads and outputs the first sampling voltage. When the first voltage register CS₁₁ is reading the first sampling voltage, the second voltage register CS₁₂ outputs the second sampling voltage. When the second voltage register CS₁₂ is reading the second sampling voltage, the first voltage register CS₁₁ outputs the first sampling voltage.

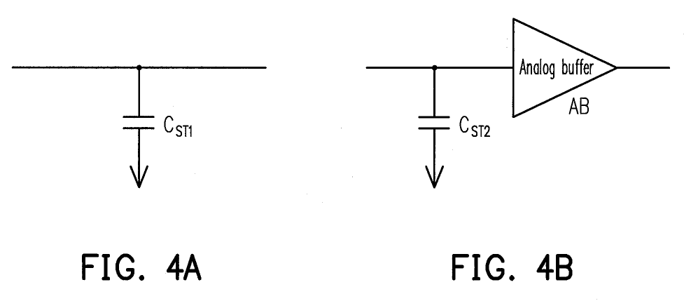

FIGS. 4A and 4B are schematic views showing respective implementation modes of voltage registers according to an embodiment of the present invention. Referring to FIGS. 4A and 4B, FIG. 4A shows an implementation mode of the first and the second voltage registers, and each voltage register is constituted by at least one capacitor C_{ST1}. FIG. 4B shows another implementation mode of the first and the second voltage registers and each voltage register is constituted by a capacitor C_{ST2} and an analog buffer AB.

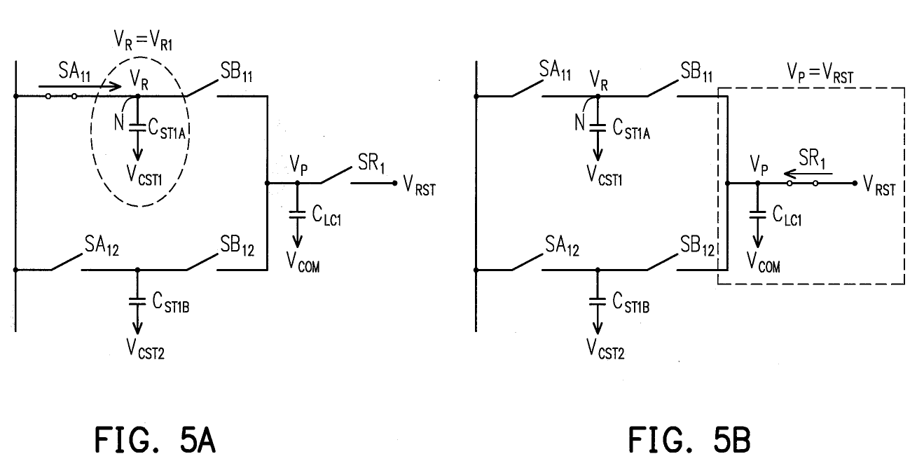

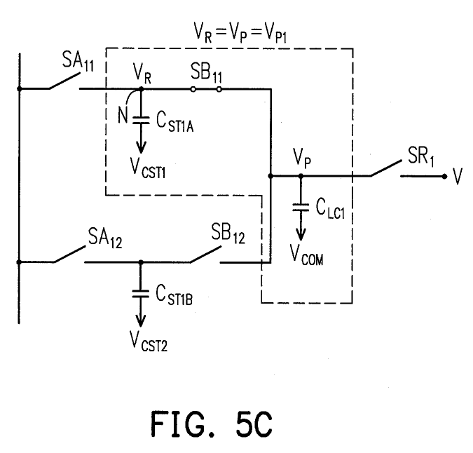

FIGS. 5A, 5B and 5C are schematic circuit diagrams showing different stages of a charge sharing process of the pixel circuit P1 in FIG. 3. FIGS. 5A through 5C show the first and the second voltage registers in the pixel circuit P₁ in the implementation mode disclosed by FIG. 4A. FIG. 5A is a schematic view showing a voltage sampling stage during the charge sharing process of the pixel circuit P₁. Referring to FIG. 5A, during this voltage sampling stage, the first sampling switch SA₁₁ is turned on, and the first output switch SB₁₁ is turned off so that a first storage capacitor C_{ST1A} charges to the first sampling voltage (i.e., the sampling operation). Suppose the first sampling voltage is V_{R1}, a voltage V_{R} at a node N currently is equal to V_{R1}.

FIG. 5B is a schematic view showing a voltage holding stage during the charge sharing process of the pixel circuit P₁. Referring to FIG. 5B, during this voltage holding stage, the first sampling switch SA₁₁ is turned off, and the first output switch SB₁₁ is also turned off and thus the voltage V_{R} at the node N is maintained on the first storage capacitor C_{ST1A} (i.e., the holding operation). Simultaneously, the reset switch SR₁ is turned on, and the second output switch SB₁₂ is also turned off. Consequently, a voltage V_{P} on a pixel electrode in the liquid crystal capacitor C_{LC1} would charge or discharge to the reset voltage V_{RST}.

FIG. 5C is a schematic view showing a charge sharing stage during the charge sharing process of the pixel circuit P₁. Referring to FIG. 5C, during this charge sharing stage, the reset switch SR₁ is turned off, and the first output switch SB₁₁ is turned on. Consequently, the storage capacitor C_{ST1A} and the liquid crystal capacitor C_{LC1} share charges until the voltage V_{R} at the node N is equal to the voltage V_{P} on the pixel electrode in the liquid crystal capacitor C_{LC1} so as to determine a gray scale of the pixel circuit P₁. Suppose the voltage V_{P} is V_{P1} after charge sharing is balanced, it is known that after the balance in the charge sharing is reached, V_{R}=V_{P}=V_{P1}. Since during the charge sharing process of the storage capacitor C_{ST1A} and the liquid crystal capacitor C_{LC1}, the charges are only transferred rather than lost. The charges lost from the storage capacitor C_{ST1A} are equal to the charges gained by the liquid crystal capacitor C_{LC1}. Arithmetic formulas expressing how charge sharing is performed between the storage capacitor C_{ST1A} and the liquid crystal capacitor C_{LC1} are described below.

In a following formula, C_{LC1} and C_{ST1A} represent respective capacitance values of the corresponding capacitors. The lost charges of the storage capacitor C_{ST1A} are expressed as (C_{ST1A}*(V_{R1}−V_{P1}) The charges gained by the liquid crystal capacitor C_{LC1} are expressed as (C_{LC1}*(V_{P1}−V_{RST}). The formulas are as follows:

$$-> {V}_{R 1} = \frac{{C}_{LC 1} \cdot ( {V}_{P 1} - {V}_{RST} )}{{C}_{ST 1 A}} + {V}_{P 1} \\ -> {V}_{R 1} = \frac{( {C}_{ST 1 A} + {C}_{LC 1} )}{{C}_{ST 1 A}} \cdot {V}_{P 1} - ( \frac{{C}_{LC 1}}{{C}_{ST 1 A}} ) \cdot {V}_{RST}$$

### When V_{RST}=0,

$${V}_{R 1} = \frac{( {C}_{ST 1 A} + {C}_{LC 1} )}{{C}_{ST 1 A}} \cdot {V}_{P 1}$$

Hence, a relationship between the voltage V_{P1} of the pixel electrode and the voltage V_{R1} stored in the storage capacitor C_{ST1A} after the charge sharing is balanced is expressed as:

$${V}_{P 1} = \frac{{C}_{ST 1 A}}{( {C}_{ST 1 A} + {C}_{LC 1} )} \cdot {V}_{R 1}$$

In the foregoing, only the process of the first sampling voltage being outputted to the liquid crystal capacitor C_{LC1} is described, but actually, a process of the second sampling voltage being outputted to the liquid crystal capacitor C_{LC1} is the same. The two processes proceed simultaneously and alternately to save the operation time. When the first voltage register is storing the first sampling voltage, the second voltage register is outputting the second sampling voltage to the liquid crystal capacitor C_{LC1}. When the first voltage register is outputting the first sampling voltage to the liquid crystal capacitor C_{LC1}, the second voltage register is storing the second sampling voltage. As mentioned above, a pixel circuit simultaneously writes data signals and illuminates single-color light sources during a period between display of a sub-frame and a next sub-frame. Thus, the illumination time is prolonged. In light of the foregoing operation principle of the pixel circuit Pi, an operation method of a pixel array and a display effect of the pixel array are described in the following.

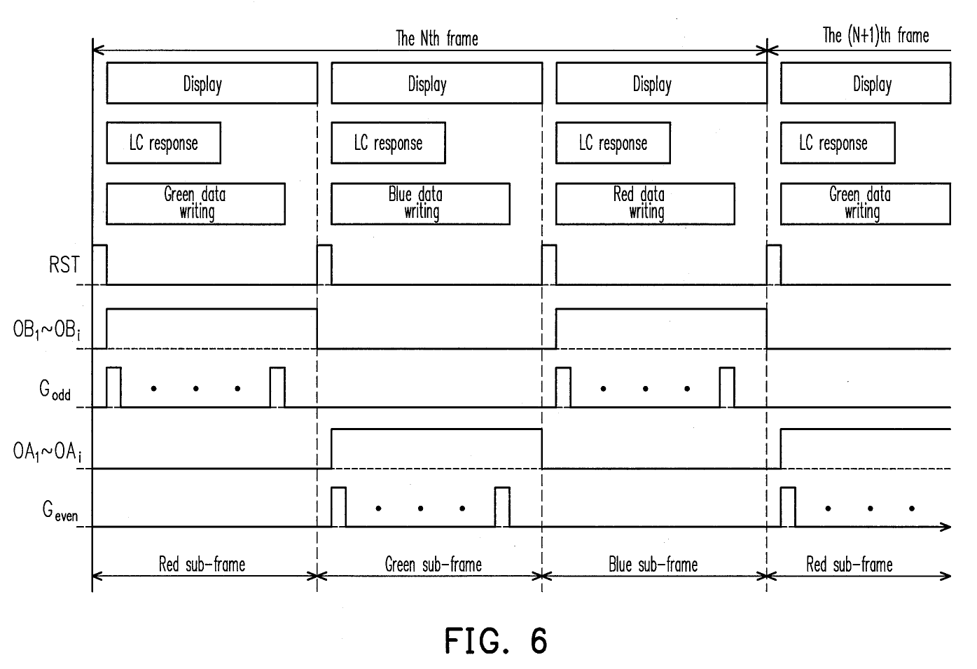

FIG. 6 is an operational timing sequence diagram of a color sequential LCD according to an embodiment of the present invention. The color sequential LCD is, for example, the LCD 200 shown by FIG. 2. Suppose the LCD panel 210 of the LCD is a pixel circuit of (i×j) arrays, including j data lines, (2×i) scan lines (as can be divided into i odd-numbered scan lines G_{odd} and i even-numbered scan lines Gₑᵥₑₙ), i first, second and third control signals RST, OB₁-OBᵢ and OA₁-OAᵢ, and (i×j) pixel circuits. The operation principle of the LCD 200 has been disclosed in the embodiment of the LCD 200 as shown by the system block diagram of FIG. 2. The operation principle of the LCD panel 210 has been disclosed in the embodiment of the pixel circuits P₁-P₄ shown by the (2×2) circuit diagram of FIG. 3. The present embodiment employs the foregoing principles in the two embodiments to explain the operational timing sequence flowchart of the pixel circuit having (i×j) arrays of the LCD panel in the color sequential LCD.

FIG. 6 shows four sub-frames of the color sequential LCD according to the present embodiment: a red sub-frame, a green sub-frame, a blue sub-frame of an N^{th} frame, and a red sub-frame of an (N+₁)^{th} frame. During the red sub-frame of the N^{th} frame, the first control signals RST of all rows of pixel circuits are first turned on (as shown by FIG. 6) to turn on all the reset switches in all the pixel circuits in the LCD panel 210 so that all the liquid crystal capacitors of the pixel circuits are reset. At this moment, all the first and the second sampling switches and the first and the second output switches are all turned off. When all the liquid crystal capacitors of the pixel circuits finish resetting, the first control signals RST of all the rows of pixel circuits are turned off.

Thereafter, the second control signals OB₁-OBᵢ of all the rows of pixel circuits are simultaneously turned on (as shown by FIG. 6) to output respectively red data signals stored in the second voltage registers of all the rows of pixel circuits in a blue sub-frame of an (N−1)^{th} frame to the corresponding liquid crystal capacitors. The operation corresponds to an LC response stage and a display stage of the red sub-frame of the N^{th} frame. The writing of the red data signals belongs to a red data writing stage of the blue sub-frame of the (N−1)^{th} (not shown by FIG. 6).

In the red sub-frame of the N^{th} frame, when the red data signals are displaying, green data signals are also storing. First, a first scan line G₁ among the scan lines G_{odd} is turned on so that all the data lines output respective green data signals to the first voltage register of a first row of pixel circuit. After the green data signals finish writing the first row of pixel circuit, the first scan line G₁ is turned off, and a second scan line G₃ among the scan lines G_{odd} is immediately turned on so that all the data lines output respective green data signals to the first voltage register of a second row of pixel circuit. The odd-numbered scan lines G_{odd} (i.e., G₁, G₃ to G₂ᵢ₋₁) sequentially turn on the first sampling switch of each of the rows of pixel circuits from the first pixel row to the last pixel row so as to input the data signals of the data lines to the first voltage register of the row of pixel circuit correspondingly. In other words, all the first voltage registers of the pixel circuits store a data signal provided by a data line respectively. The operation of storing green data signals in the first voltage register corresponds to the green data signal writing stage in the red sub-frame of the N^{th} frame as shown by FIG. 6. It is noted from the red sub-frame of the N^{th} frame of FIG. 6 that at the same time when the green data signal is writing, the red data signal is also displaying. After each row of pixel circuit is sequentially written with the green data signal and the red data signals finish displaying, a next sub-frame—the green sub-frame—is entered.

In the green sub-frame of the N^{th} frame, the first control signal RST is first turned on (as shown by FIG. 6) to turn on all the reset switches of the rows of pixel circuits so as to reset the liquid crystal capacitors of all the pixels. Currently, all the first and the second sampling switches and the first and the second output switches are turned off (as shown by FIG. 6). After resetting, the first control signal RST is turned off again.

Next, the third control signals OA₁-OAᵢ are turned on simultaneously to output the respective green data signals stored in the first voltage registers in the red sub-frame of the N^{th} frame to the corresponding liquid crystal capacitors. The operation corresponds to the LC response stage and the display stage of the green sub-frame as shown by FIG. 6. At the same time when the green data signals are displaying, blue data signals are also writing. First, a first scan line G₂ among the scan lines Gₑᵥₑₙ is turned on so that all the data lines output respective blue data signals to the second voltage register of the first row of pixel circuit. After the blue data signals finish writing the first row of pixel circuit, the first scan line G₂ is turned off, and a second scan line G₄ among the scan lines Gₑᵥₑₙ is immediately turned on so that all the data lines output respective blue data signals to the second voltage register of the second row of pixel circuit.

The even-numbered scan lines Gₑᵥₑₙ (i.e., G₂, G₄ to G₂ᵢ) sequentially turn on the second sampling switch of each row of pixel circuit from the first pixel row to the last pixel row so as to input the data signals of the data lines to the second voltage register of the corresponding pixel row. In other words, all the second voltage registers of the pixel circuits store data signals provided by a data line respectively. The foregoing operation of storing data signals in the second voltage register corresponds to the blue data signal writing stage in the green sub-frame as shown by FIG. 6. At the same time when the blue data signals are writing row by row, the green data signals are also displaying until each row of pixel circuit is sequentially written with the blue data signals, and the green data signals finish displaying. Afterwards, the next sub-frame—the blue sub-frame—is entered.

The operation of the blue sub-frame is the same as those of the green sub-frame and the red sub-frame. The blue data signals are outputted by the second voltage register of each of the pixels to the liquid crystal capacitors to display the blue sub-frame. The first voltage register stores the red data signals. After the blue sub-frame of the N^{th} frame finishes displaying, the red sub-frame of the (N+1)^{th} frame is entered. The first voltage register of each of the pixels outputs the red data signals to the liquid crystal capacitor in order to display the red sub-frame.

In summary, the pixel circuit of the color sequential LCD of the present invention includes the first voltage register and the second voltage register. When the first or the second voltage register is reading data signals, the other voltage register is transmitting data signals to the liquid crystal capacitor to display frames. In the circuit structure and the operation method, writing and displaying of the data signals are executed simultaneously, and the illumination time of the pixels is prolonged. In addition, since the sample and hold circuit structure is employed in the present invention, after the pixel circuit is sampled and held row by row, the data signals of the entire frame are outputted to the liquid crystal capacitor of each pixel at one time to display frames. This operation method of the LC response in the frames prevents uneven LC response covered by the sequential LC response. Moreover, the illumination time of the pixel circuit in the present invention is longer, and thus color sequential displays with higher frequencies can be operated to further reduce color breakup. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A pixel circuit of a color sequential liquid crystal display (LCD), comprising:
a first and a second sampling switches for transmitting a first and a second sampling voltages during a first and a second sub-frame periods, respectively;
a first voltage register coupled to the first sampling switch for registering the first sampling voltage during the first sub-frame period and outputting the first sampling voltage during the second sub-frame period;
a second voltage register coupled to the second sampling switch for registering the second sampling voltage during the second sub-frame period and outputting the second sampling voltage during the first sub-frame period;
a first and a second output switches coupled to the first and the second voltage registers, respectively, for transmitting the first and the second sampling voltages during the second and the first sub-frame periods respectively;
a liquid crystal capacitor coupled to the first and the second output switches and a common voltage for receiving the second and the first sampling voltages during the first and the second sub-frame periods; and
a reset switch coupled to the liquid crystal capacitor for transmitting a reset voltage to reset the liquid crystal capacitor before the first and the second output switches transmit the first and the second sampling voltages during the second and the first sub-frame periods, respectively.

2. The pixel circuit of the color sequential LCD as claimed in claim 1, wherein the first and the second voltage registers are capacitive voltage registers.

3. The pixel circuit of the color sequential LCD as claimed in claim 2, wherein each of the first and the second voltage registers is constituted by at least one capacitor.

4. The pixel circuit of the color sequential LCD as claimed in claim 2, wherein each of the first and the second voltage registers is constituted by at least one capacitor and one analog buffer.

5. The pixel circuit of the color sequential LCD as claimed in claim 2, wherein the second voltage register and the liquid crystal capacitor perform a charge sharing process during the first sub-frame period to determine a gray scale of the pixel circuit.

6. The pixel circuit of the color sequential LCD as claimed in claim 2, wherein the first voltage register and the liquid crystal capacitor perform a charge sharing process during the second sub-frame period to determine a gray scale of the pixel circuit.

7. A color sequential LCD, comprising:
an LCD panel, at least comprising:
a pixel circuit, comprising:
a first and a second sampling switches for transmitting a first and a second sampling voltages during a first and a second sub-frame periods, respectively;
a first voltage register coupled to the first sampling switch for registering the first sampling voltage during the first sub-frame period and outputting the first sampling voltage during the second sub-frame period;
a second voltage register coupled to the second sampling switch for registering the second sampling voltage during the second sub-frame period and outputting the second sampling voltage during the first sub-frame period;
a first and a second output switches coupled to the first and the second voltage registers, respectively, for transmitting the first and the second sampling voltages during the second and the first sub-frame periods, respectively;
a liquid crystal capacitor coupled to the first and the second output switches and a common voltage for receiving the second and the first sampling voltages during the first and the second sub-frame periods; and
a reset switch coupled to the liquid crystal capacitor for transmitting a reset voltage to reset the liquid crystal capacitor before the first and the second output switches transmit the first and the second sampling voltages during the second and the first sub-frame periods, respectively.

8. The color sequential LCD as claimed in claim 7, wherein the LCD panel further comprises:
a first and a second scan lines coupled to the first and the second sampling switches, respectively, for transmitting a first and a second scan signals to enable the first and the second sampling switches during the first and the second sub-frame periods; and
a data line coupled to the first and the second sampling switches for transmitting the first and the second sampling voltages during the first and the second sub-frame periods.

9. The color sequential LCD as claimed in claim 8, further comprising:
a timing controller;
a gate driver coupled to and controlled by the timing controller for providing the first and the second scan signals to the first and the second scan lines during the first and the second sub-frame periods respectively; and
a source driver coupled to and controlled by the timing controller for providing the first and the second sampling voltages to the data lines during the first and the second sub-frame periods respectively.

10. The color sequential LCD as claimed in claim 9, further comprising:
a light-emitting diode (LED) backlight module for providing a surface light source required by the LCD panel.

11. The color sequential LCD as claimed in claim 7, further comprising:
a control unit coupled to the first and the second output switches and the reset switch for providing a first control signal to enable the reset switch before the first and the second output switches transmit the first and the second sampling voltages during the second and the first sub-frame periods respectively.

12. The color sequential LCD as claimed in claim 11, further comprising:
a reset voltage generator coupled to the reset switch for providing the reset voltage to the reset switch before the first and the second output switches transmit the first and the second sampling voltages during the second and the first sub-frame periods respectively.

13. The color sequential LCD as claimed in claim 11, wherein the control unit further provides a second and a third control signals to enable the second and the first output switches respectively after the liquid crystal capacitor is reset during the first and the second sub-frame periods.

14. The color sequential LCD as claimed in claim 7, wherein the first and the second voltage registers are capacitive voltage registers.

15. The color sequential LCD as claimed in claim 14, wherein each of the first and the second voltage registers is constituted by at least one capacitor.

16. The color sequential LCD as claimed in claim 14, wherein each of the first and the second voltage registers is constituted by at least one capacitor and one analog buffer.

17. The color sequential LCD as claimed in claim 14, wherein the second voltage register and the liquid crystal capacitor perform a charge sharing process during the first sub-frame period to determine a gray scale of the pixel circuit.

18. The color sequential LCD as claimed in claim 14, wherein the first voltage register and the liquid crystal capacitor perform a charge sharing process during the second sub-frame period to determine a gray scale of the pixel circuit.
